(19) United States
(12) Patent Application Publication
(10) Pub. No.: US 2024/0136120 A1
(43) Pub. Date: Apr. 25, 2024

(54) COIL DEVICE

(71) Applicant: TDK CORPORATION, Tokyo (JP)

(72) Inventors: Ge LI, Tokyo (JP); Toshiyuki HORIKAWA, Tokyo (JP)

(73) Assignee: TDK CORPORATION, Tokyo (JP)

(21) Appl. No.: 18/491,149

(22) Filed: Oct. 19, 2023

(30) Foreign Application Priority Data
Oct. 19, 2022 (JP) 2022-168610

(51) Int. Cl. H01F 27/32; H01F 38/08

(52) U.S. Cl. CPC H01F 27/325; H01F 38/08; H01F 27/306

(57) ABSTRACT

A coil device includes a bobbin, a first coil provided to the bobbin, and a second coil provided outside the first coil. The first coil includes a first portion provided inside the second coil and a second portion next to the first portion and the second coil along a winding axis of the first portion. A first protrusion portion, a second protrusion portion, and a partition protrusion portion each protruding in a radial direction of the bobbin are formed on an outer peripheral surface of the bobbin.

### BACKGROUND OF THE INVENTION

The present disclosure relates to a coil device used as a leakage transformer or so.

As a coil device used as a leakage transformer, there is a coil device in which a second coil is stacked on a first coil, as disclosed in, for example, Patent Document 1. This type of coil device is known as a high-coupling-type coil device with a high coupling coefficient between the first coil and the second coil.
Patent Document 1: JP2006310648 (A)

### BRIEF SUMMARY OF THE INVENTION

As in the coil device of Patent Document 1, when the second coil is stacked on the first coil, however, a winding disorder of the first coil and/or the second coil may cause variations in leakage magnetic flux (leakage inductance) between the first coil and the second coil and reduce the reliability of the coil device.

The present disclosure has been achieved under such circumstances. It is an object of the disclosure to provide a coil device capable of preventing variations in leakage magnetic flux and adjusting the leakage magnetic flux to an appropriate value.

To achieve the above object, a coil device according to the present disclosure comprises:
a bobbin;
a first coil provided to the bobbin; and
a second coil provided outside the first coil;
wherein
the first coil includes:
   a first portion provided inside the second coil; and
   a second portion next to the first portion and the second coil along a winding axis of the first portion, the bobbin includes:
a first region for disposing the first portion; and
a second region for disposing the second portion, a first protrusion portion, a second protrusion portion, and a partition protrusion portion each protruding in a radial direction of the bobbin are formed on an outer peripheral surface of the bobbin,
the first protrusion portion is located in the first region,
the second protrusion portion is located in the first region and protrudes more outward than the first protrusion portion in the radial direction of the bobbin, and
the partition protrusion portion is located between the first region and the second region and protrudes more outward than the first protrusion portion in the radial direction of the bobbin.

In the coil device according to the present disclosure, the first coil includes a first portion provided inside the second coil and a second portion next to the first portion and the second coil along a winding axis of the first portion. Since the second coil is provided outside the first portion of the first coil, the effect of reducing leakage magnetic flux is exhibited. Moreover, since the second coil is next to the second portion of the first coil along the winding axis of the first portion, the effect of increasing leakage magnetic flux is exhibited. Thus, the coil device according to the present disclosure has a portion for contributing to reduction in leakage magnetic flux and a portion for contributing to increase in leakage magnetic flux. Then, the leakage magnetic flux can be adjusted to an appropriate value by organically combining these portions.

In particular, in the coil device according to the present disclosure, a first protrusion portion, a second protrusion portion, and a partition protrusion portion each protruding in a radial direction of the bobbin are formed on an outer peripheral surface of the bobbin. Since the first protrusion portion is located in the first region, for example, the first portion can be formed in the first region while fixing the first wire to the first protrusion portion. This makes it possible to prevent variations in the winding shape and winding position of the first portion. Moreover, the second protrusion portion is located in the first region, and the partition protrusion portion is located between the first region and the second region. Then, these protrusion portions protrude more outward than the first protrusion portion in the radial direction of the bobbin. Thus, for example, the second coil can be formed outside the first portion while fixing the second wire to the second protrusion portion and/or the partition protrusion portion. This makes it possible to prevent variations in the winding shape and winding position of the second coil. As a result, a winding disorder is less likely to occur in the first coil and/or the second coil, and it is possible to prevent variations in the leakage magnetic flux between the first coil and the second coil.

The first protrusion portion may comprise first protrusion portions provided along an axial direction of the bobbin, and the second protrusion portion may be provided between the first protrusion portions next to each other in the first region. In this case, the second coil can be formed outside the first portion while fixing the second wire to the second protrusion portion at any position of the first region in the axial direction of the bobbin. This makes it possible to prevent variations in the winding shape and winding position of the second coil.

The second coil may include mutually continuous second turn portions, one of the second turn portions may be in contact with the second protrusion portion, and another one of the second turn portions may be in contact with the partition protrusion portion. Variations in the winding shape and winding position of the second coil can be prevented by bringing one of the second turn portions into contact with the second protrusion portion and fixing this position. Moreover, variations in the winding shape and winding position of the second coil can be prevented by bringing another one of the second turn portions into contact with the partition protrusion portion and fixing this position.

The second coil may include layers provided along the radial direction of the bobbin, one of the second turn portions in an outermost layer of the second coil may be in contact with the second protrusion portion, and another one of the second turn portions in the outermost layer of the second coil may be in contact with the partition protrusion portion. In this case, one of the second turn portions in the outermost layer of the second coil is fixed to the second protrusion portion and the partition protrusion portion, and variations in the winding shape and winding position of the second coil can be prevented.

The second protrusion portion may comprise second protrusion portions provided along the axial direction of the bobbin, and the second turn portions may be provided between the second protrusion portions next to each other. In this case, since the second wire can be wound continuously (without crossing over the second protrusion portions next to each other) between the second protrusion portions next to each other, the second coil is easily formed.

The first protrusion portion may comprise first protrusion portions provided along the axial direction of the bobbin, the first portion may include mutually continuous first turn portions, and one of the first turn portions may be provided between the first protrusion portions next to each other. In this case, since a single first turn portion is interposed between the first protrusion portions next to each other, the winding position of each of the first turn portions can be fixed. This makes it possible to prevent variations in the winding shape and winding position of the first portion and makes it easy to adjust the leakage magnetic flux.

The first portion and a first layer of the second portion may be continuous to each other. In this case, it is possible to prevent variations in the winding shape and winding position of the first coil between the first portion and the first layer of the second portion.

The first coil may be formed by a first wire wound in a coil shape, the second coil may be formed by a second wire wound in a coil shape, the first protrusion portion and the second protrusion portion may extend along a circumferential direction of the bobbin, the bobbin may include: a first notch formed at a part of an extension direction of the first protrusion portion; and a second notch formed at a part of an extension direction of the second protrusion portion, the first wire may pass through the first notch, and the second wire may pass through the second notch. In this case, for example, when the first portion is formed in the first region, the first wire can be wound from one side to the other side via the first notch along the axial direction of the bobbin without being hindered by the first protrusion portion. Moreover, for example, when the second coil is formed in the first region, the second wire can be wound from one side to the other side via the second notch along the axial direction of the bobbin without being hindered by the second protrusion portion.

The first coil may be formed by a first wire wound in a coil shape, and a protrusion length of the first protrusion portion may be equal to a diameter of the first wire. In this case, when the first turn portion is disposed next to the first protrusion portion, the step between the first turn portion and the first protrusion portion can be reduced. Thus, when the second turn portion is disposed on the first turn portion and the first protrusion portion so as to cross over the first protrusion portion and the first protrusion portion, the positional displacement of the second turn portion can be prevented.

### BRIEF DESCRIPTION OF THE DRAWING(S)

FIG. 1 is a perspective view of a coil device according to an embodiment of the present disclosure;

FIG. 2 is an exploded perspective view of the coil device shown in FIG. 1;

FIG. 3 is a perspective view of a bobbin shown in FIG. 2;

FIG. 4 is a cross-sectional view of the coil device shown in FIG. 1 taken along the line IV-IV;

FIG. 5 is a side view of a first wire wound around the bobbin shown in FIG. 3; and

FIG. 6 is a cross-sectional view of the coil device shown in FIG. 1 taken along the line VI-VI.

### DETAILED DESCRIPTION OF THE INVENTION

Hereinafter, an embodiment of the present disclosure is described with reference to the figures. Although the embodiment is described with reference to the figures as necessary, the illustrated contents are only schematically and exemplarily shown for understanding of the present disclosure, and the appearance, dimensional ratio, etc. may be different from the actual one. Hereinafter, the present disclosure is specifically described based on the embodiment, but the present disclosure is not limited to the embodiment.

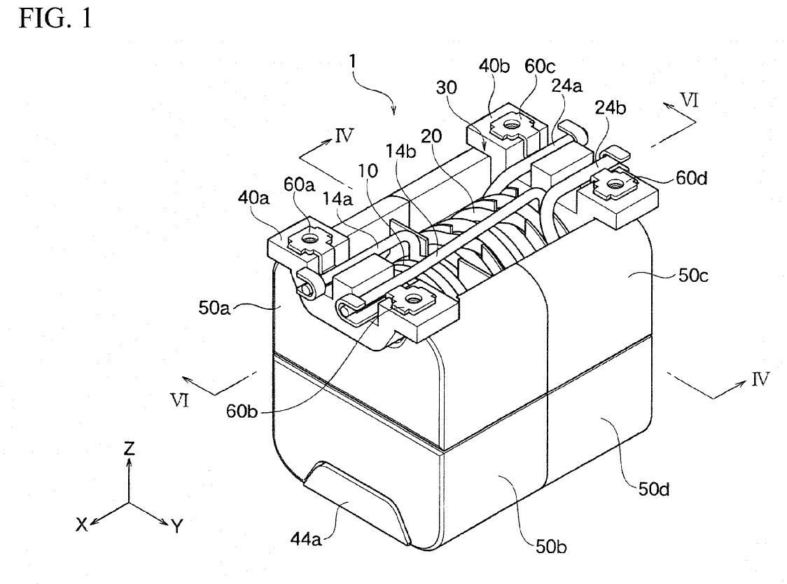

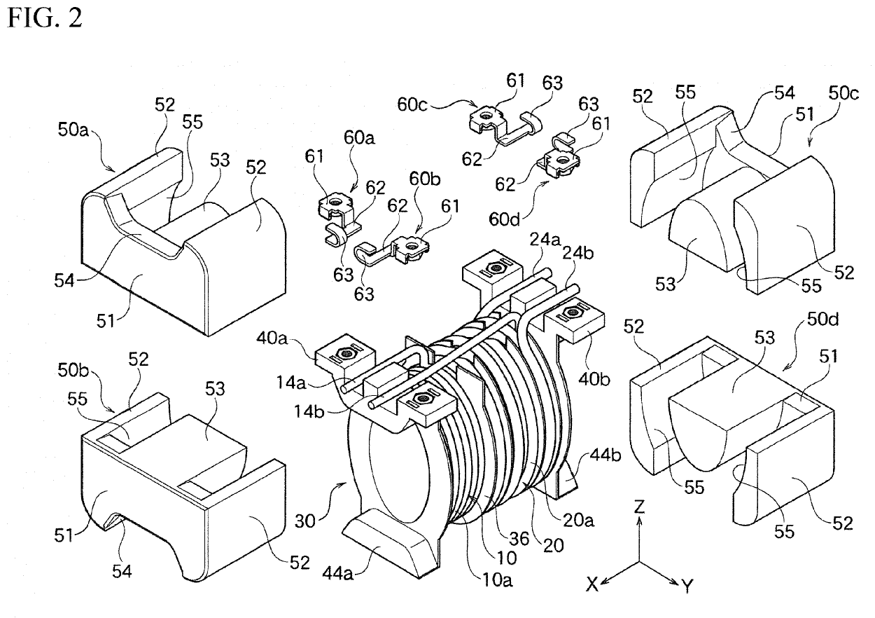

A coil device 1 shown in FIG. 1 functions as, for example, a leakage transformer and is mounted in power supply circuits of various electric devices. As shown in FIG. 2, the coil device 1 includes a first coil 10 formed by winding a first wire 10a, a second coil 20 formed by winding a second wire 20a, and a bobbin 30. In addition to the first coil 10, the second coil 20, and the bobbin 30, the coil device 1 may include cores 50a to 50d and terminals 60a to 60d. In the present embodiment, the first coil 10 and the second coil 20 are provided to the bobbin 30. However, the first coil 10 and the second coil 20 may be provided to the cores 50a to 50d without the bobbin 30.

In the figures, the X-axis is an axis corresponding to the longitudinal direction (axial direction) of the bobbin 30, the Y-axis is an axis corresponding to the lateral direction of the bobbin 30 (the direction in which the terminals 60a and 60b face each other), and the Z-axis is an axis perpendicular to the X-axis and the Y-axis. Hereinafter, for each of the X-axis, Y-axis, and Z-axis, the direction toward the center of the coil device 1 is defined as “inside”, and the direction away from the center of the coil device 1 is defined as “outside”. Also, the positive side of the Z-axis is defined as “upper”, and the negative side of the Z-axis is defined as “lower”.

The coil device 1 is a horizontal-type coil device in which the core axis of the bobbin 30 is disposed in parallel to a mounting board (not shown). In the present embodiment, “parallel” is not limited to being strictly parallel, and an error within, for example, ±10 degrees is allowed. Also, “perpendicular” is not limited to being strictly perpendicular, and an error within, for example, ±10 degrees is allowed.

For example, the coil device 1 has a length of 20 to 60 mm along the X-axis, a length of 10 to 60 mm along the Y-axis, and a length of 10 to 70 mm along the Z-axis. However, the size of the coil device 1 is not limited to this.

The first wire 10a and the second wire 20a are composed of, for example, insulation-coated wires obtained by coating copper wires with insulation. The first wire 10a and the second wire 20a are composed of single wires, but may be composed of twisted wires. The first wire 10a or the second wire 20a has a diameter of, for example, 1.0 to 3.0 mm. The diameter of the second wire 20a is larger than the diameter of the first wire 10a, but may be equivalent to or smaller than the diameter of the first wire 10a. Note that, in the present embodiment, “equivalent”, “equal”, “same”, or “similar” is not limited to being strictly equal and allows an error within, for example, ±10%.

The cores 50a to 50d are E-shaped cores and have the same shape. However, any of the cores 50a to 50d may have a different shape. Materials for the cores 50a to 50d are not limited and include magnetic materials, such as metal and ferrite. The cores 50a and 50b may be integrated, and the cores 50c and 50d may be integrated.

The cores 50a to 50d are attached to the bobbin 30. The core 50a includes a base portion 51, outer leg portions 52 formed at both ends of the base portion 51 in the Y-axis direction, and a middle leg portion 53 formed between one outer leg portion 52 and the other outer leg portion 52. The configurations of the cores 50b to 50d are similar to the configuration of the core 50a and are not thus described in detail.

The base portion 51 may be provided with a base recess portion 54. The base recess portion 54 is formed on a side surface of the base portion 51, namely, a surface perpendicular to the surface on which the middle leg portion 53 is formed. The side surface of the base portion 51 is recessed at the position of the base recess portion 54. At least a part of a terminal block 40a of the bobbin 30 is disposed in the base recess portion 54 of the core 50a. At least a part of the terminal block 40b of the bobbin 30 is disposed in the base recess portion 54 of the core 50c. A leg portion 44a of the bobbin 30 is disposed in the base recess portion 54 of the core 50b. A leg portion 44b of the bobbin 30 is disposed in the base recess portion 54 of the core 50d.

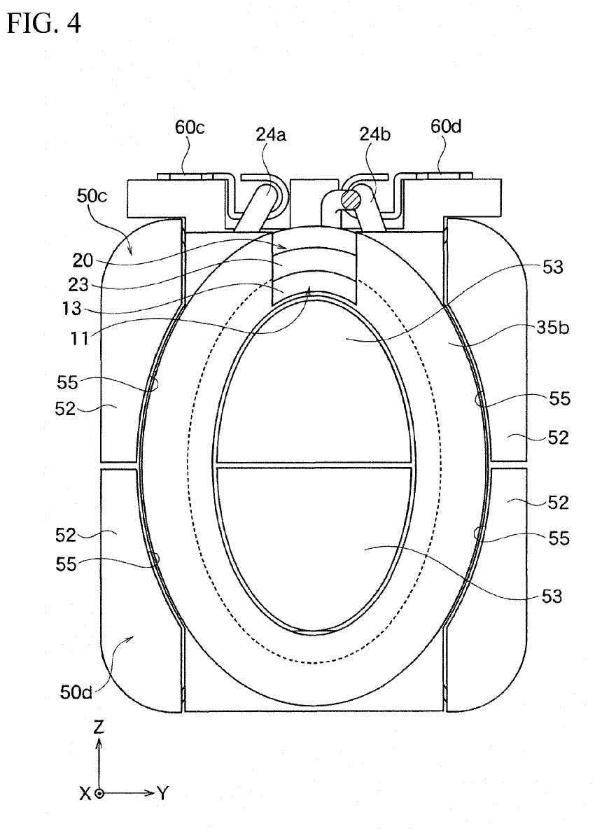

The outer leg portions 52 may be provided with outer leg recess portions 55. The outer leg recess portions 55 are formed on inner surfaces of the outer leg portions 52, namely, the surfaces facing the middle leg portion 53. The inner surfaces of the outer leg portions 52 are recessed at the positions of the outer leg recess portions 55. In the cores 50a and 50b, the inner surfaces of the outer leg portions 52 may be curved along the outer peripheral surface of the first coil 10. In the cores 50c and 50d, the inner surfaces of the outer leg portions 52 may be curved along the outer peripheral surface of the second coil 20 (FIG. 4).

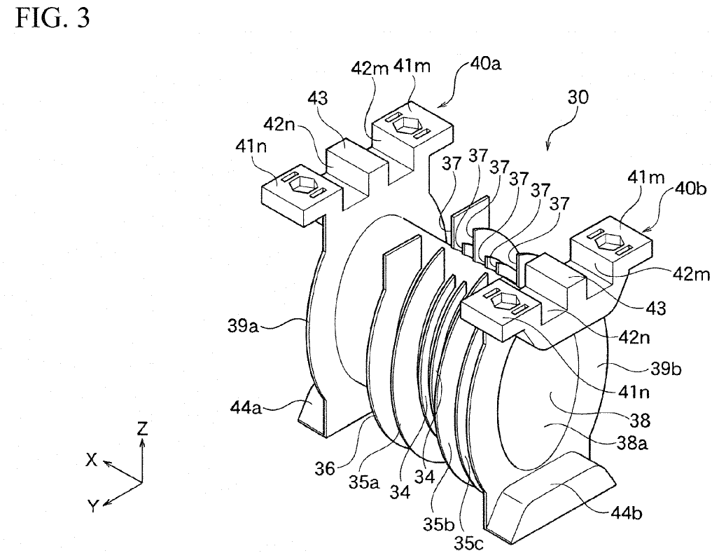

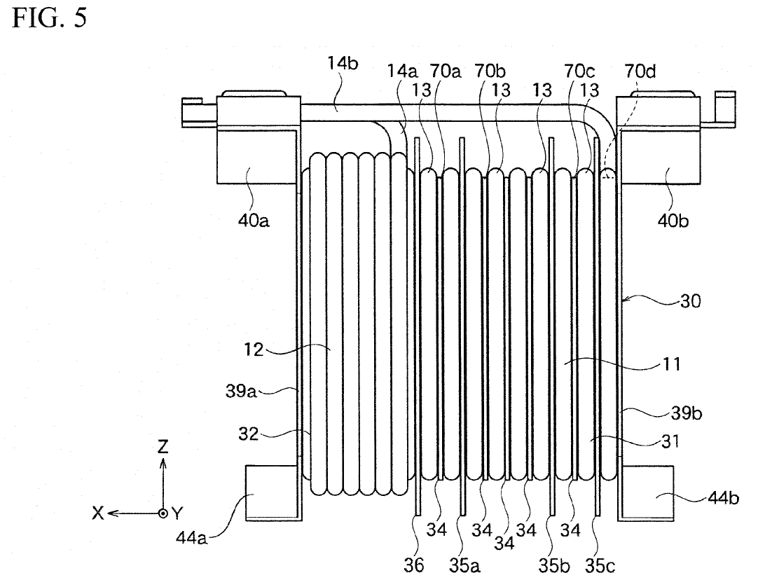

As shown in FIG. 3, the bobbin 30 is composed of an insulating material, such as resin. The bobbin 30 includes a tube portion 38. The tube portion 38 includes a through hole 38a, and the middle leg portions 53 of the cores 50a to 50d (FIG. 2) are inserted into the through hole 38a. The first coil 10 is disposed (wound) on the outer peripheral surface of the tube portion 38 (FIG. 5).

A flange portion 39a may be formed at one end of the tube portion 38 in the X-axis direction, and a flange portion 39b may be formed at the other end of the tube portion 38 in the X-axis direction. The flange portions 39a and 39b protrude along the radial direction of the tube portion 38 and extend along the circumferential direction of the tube portion 38. The flange portions 39a and 39b continuously encircle the tube portion 38 along its circumferential direction, but may intermittently encircle the tube portion 38 along its circumferential direction. The flange portion 39a and the flange portion 39b have the same shape, but may have different shapes.

The flange portion 39a may be provided with a terminal block 40a and a leg portion 44a. The flange portion 39b may be provided with a terminal block 40b and a leg portion 44b. The leg portion 44a is located at the lower end of the flange portion 39a. At least a part of the leg portion 44a may protrude outward in the X-axis from the end surface of the flange portion 39a. The leg portion 44b is located at the lower end of the flange portion 39b. At least a part of the leg portion 44b may protrude outward in the X axis from the end surface of the flange portion 39b. The leg portions 44a and 44b have a role of supporting the tube portion 38.

The terminal block 40a may be located at the upper end of the flange portion 39a and may protrude outward in the X-axis from the end surface of the flange portion 39a. The terminal block 40a may include terminal fixation portions 41m and 41n, groove portions 42m and 42n, and an insulation portion 43. However, the configuration of the terminal block 40a is not limited to the configuration shown in FIG. 3.

The terminal fixation portion 41m is formed at one end of the terminal block 40a in the Y-axis direction, and the terminal fixation portion 41n is formed at the other end of the terminal block 40a in the Y-axis direction. The terminals 60a and 60b (FIG. 2) are fixed to the terminal fixation portions 41m and 41n, respectively. The terminal fixation portions 41m and 41n may be provided with holes for engaging with the terminals 60a and 60b, respectively.

The insulation portion 43 is formed at a central part of the terminal block 40a in the Y-axis direction. The insulation portion 43 has a role of insulating the terminal 60a (FIG. 2) from the terminal 60b. The groove portion 42m is formed between the terminal fixation portion 41m and the insulation portion 43 and penetrates the terminal block 40a along the X-axis. A part of the terminal 60a (FIG. 2) is disposed in the groove portion 42m. The groove portion 42n is formed between the terminal fixation portion 41n and the insulation portion 43 and penetrates the terminal block 40a along the X-axis. A part of the terminal 60b (FIG. 2) is disposed in the groove portion 42n.

The terminal block 40b may be located at the upper end of the flange portion 39b and may protrude outward in the X-axis from the end surface of the flange portion 39b. The terminal block 40b may include terminal fixation portions 41m and 41n, groove portions 42m and 42n, and an insulation portion 43. However, the configuration of the terminal block 40b is not limited to the configuration shown in FIG. 3.

The terminal fixation portion 41m is formed at one end of the terminal block 40b in the Y-axis direction, and the terminal fixation portion 41n is formed at the other end of the terminal block 40b in the Y-axis direction. The terminals 60c and 60d (FIG. 2) are fixed to the terminal fixation portions 41m and 41n, respectively. The terminal fixation portions 41m and 41n may be provided with holes for engaging with the terminals 60c and 60d (FIG. 2), respectively.

The insulation portion 43 is formed at a central part of the terminal block 40b in the Y-axis direction. The insulation portion 43 has a role of insulating the terminal 60c (FIG. 2) from the terminal 60d. The groove portion 42m is formed between the terminal fixation portion 41m and the insulation portion 43 and penetrates the terminal block 40b along the X-axis. A part of the terminal 60c (FIG. 2) is disposed in the groove portion 42m. The groove portion 42n is formed between the terminal fixation portion 41n and the insulation portion 43 and penetrates the terminal block 40b along the X-axis. A part of the terminal 60d (FIG. 2) is disposed in the groove portion 42n.

The outer peripheral surface of the tube portion 38 may be provided with a partition protrusion portion 36 protruding in the radial direction of the tube portion 38, first protrusion portions 34 protruding in the radial direction of the tube portion 38, and second protrusion portions 35a to 35c protruding in the radial direction of the tube portion 38. The partition protrusion portion 36 is located between the flange portion 39a and the flange portion 39b and extends along the circumferential direction of the tube portion 38. The partition protrusion portion 36 is located on one side of the center in the axial direction of the tube portion 38, but may be located at the center in the axial direction of the tube portion 38 or on the other side of the center in the axial direction of the tube portion 38. The partition protrusion portion 36 protrudes outward in the tube portion 38 from the first protrusion portions 34. The protrusion length of the partition protrusion portion 36 is not limited, but may be, for example, twice or three times or more the protrusion length of the first protrusion portions 34.

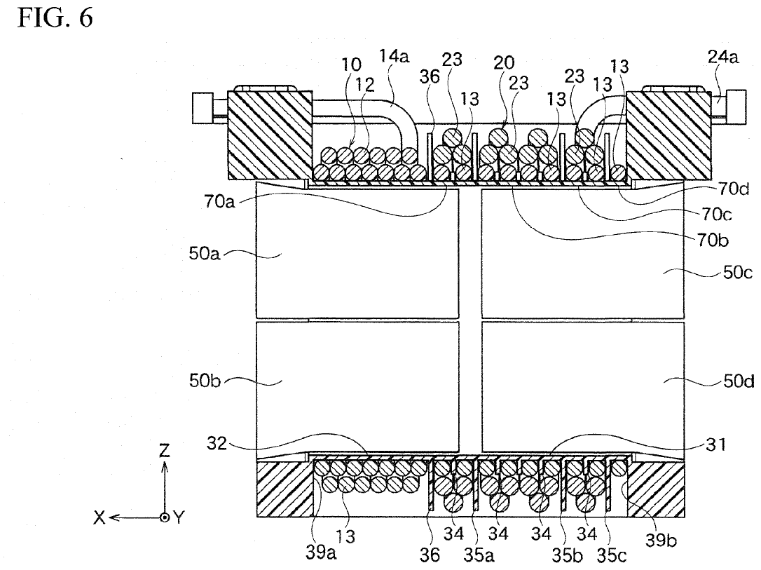

The partition protrusion portion 36 may protrude outward from the position of the outer peripheral surface of the first coil 10 (FIG. 6) or the outer peripheral surface of the second coil 20 along the radial direction of the tube portion 38. The protrusion length of the partition protrusion portion 36 is not limited, but for example, may be twice or three times or more the diameter of the first wire 10a or may be twice or three times or more the diameter of the second wire 20a.

A notch 37 may be formed in a part of the partition protrusion portion 36 in its extending direction (circumferential direction). At the position of the notch 37, a gap is formed between one end and the other end of the partition protrusion portion 36 in its extending direction. The notch 37 is for passing the first wire 10a (FIG. 2) from one side to the other side in the X-axis direction through the partition protrusion portion 36. Note that, the number of notches 37 is one, but may be plural. Moreover, the position of the notch 37 is not limited.

The first protrusion portions 34 are arranged along the axial direction of the tube portion 38. The first protrusion portions 34 are located between the partition protrusion portion 36 and the flange portion 39b and extend along the circumferential direction of the tube portion 38. In FIG. 5, five first protrusion portions 34 are arranged along the axial direction of the tube portion 38, but the number of first protrusion portions 34 is not limited to this. As shown in FIG. 5, the protrusion length of the first protrusion portions 34 is smaller than the protrusion length of the partition protrusion portion 36. The protrusion length of the first protrusion portions 34 is equal to the diameter of the first wire 10a, but may be smaller or larger than the diameter of the first wire 10a. For example, the protrusion length of the first protrusion portions 34 is ½ times or more and 2 times or less the diameter of the first wire 10a.

The width of the first protrusion portions 34 in the X-axis direction is equal to the width of the partition protrusion portion 36 in the X-axis direction, but may be larger or smaller than the width of the partition protrusion portion 36 in the X-axis direction. The width of the first protrusion portions 34 in the X-axis direction is smaller than the diameter of the first wire 10a, but may be equal to or larger than the diameter of the first wire 10a. For example, the width of the first protrusion portions 34 in the X-axis direction is ⅕ times or more and 2 times or less the diameter of the first wire 10a.

As shown in FIG. 3, notches 37 may be formed in a part of the first protrusion portions 34 in their extending directions (circumferential directions). At the positions of the notches 37, gaps are formed between one ends and the other ends of the first protrusion portions 34 in their extending directions. The notches 37 are for passing the first wire 10a (FIG. 2) from one side to the other side in the X-axis direction through the first protrusion portions 34. Note that, the number of notches 37 for each of the first protrusion portions 34 is one, but may be plural. Moreover, the positions of the notches 37 are not limited.

As shown in FIG. 6, the distance between one first protrusion portion 34 and the other first protrusion portion 34 next to each other in the X-axis direction is larger than the diameter of the first wire 10a. The distance between one first protrusion portion 34 and the other first protrusion portion 34 next to each other may be less than twice the diameter of the first wire 10a or may be smaller than the diameter of the second wire 20a.

The distance between the first protrusion portion 34 and the partition protrusion portion 36 next to each other in the X-axis direction is larger than the diameter of the first wire 10a. The distance between the first protrusion portion 34 and the partition protrusion portion 36 may be less than twice the diameter of the first wire 10a or may be smaller than the diameter of the second wire 20a. Note that, the distances between the above-mentioned two sections (the section between one first protrusion portion 34 and the other first protrusion portion 34 and the section between the first protrusion portion 34 and the partition protrusion portion 36) may be equal to or different from each other.

The first protrusion portion 34 is not disposed next to the flange portion 39b, but may be disposed next to the flange portion 39b.

As shown in FIG. 3, the second protrusion portions 35a to 35c are arranged along the axial direction of the tube portion 38. The second protrusion portions 35a to 35c are located between the partition protrusion portion 36 and the flange portion 39b and extend along the circumferential direction of the tube portion 38. In FIG. 5, three second protrusion portions 35a to 35c are arranged along the axial direction of the tube portion 38, but the number of second protrusion portions is not limited to this.

The second protrusion portions 35a to 35c protrude more outward than the first protrusion portion 34 in the radial direction of the tube portion 38. The protrusion length of the second protrusion portions 35a to 35c is equal to the protrusion length of the partition protrusion portion 36, but may be smaller or larger than the protrusion length of the partition protrusion portion 36. The protrusion length of the second protrusion portions 35a to 35c may be larger than the diameter of the first wire 10a or the second wire 20a (FIG. 2). For example, the protrusion length of the second protrusion portions 35a to 35c may be equal to or larger than the sum of the diameter of the first wire 10a and the diameter of the second wire 20a.

The width of the second protrusion portions 35a to 35c in the X-axis direction is equal to the width of the first protrusion portion 34 or the partition protrusion portion 36 in the X-axis direction, but may be larger or smaller than the width of the first protrusion portion 34 or the partition protrusion portion 36 in the X-axis direction. The width of the second protrusion portions 35a to 35c in the X-axis direction is smaller than the diameter of the first wire 10a, but may be equal to or larger than the diameter of the first wire 10a. For example, the width of the second protrusion portions 35a to 35c in the X-axis direction is ⅕ times or more and 2 times or less the diameter of the first wire 10a.

As shown in FIG. 3, notches 37 may be formed in a part of the second protrusion portions 35a to 35c in their extending directions (circumferential directions). At the positions of the notches 37, gaps are formed between one ends and the other ends of the second protrusion portions 35a to 35c in their extending directions. The notches 37 are for passing the first wire 10a and/or the second wire 20a (FIG. 2) from one side to the other side in the X-axis direction through the second protrusion portions 35a to 35c. Note that, the number of notches 37 for each of the second protrusion portions 35a to 35c is one, but may be plural. Moreover, the positions of the notches 37 are not limited.

As shown in FIG. 6, the distance between one second protrusion portion 35a and the other second protrusion portion 35b next to each other in the X-axis direction is larger than the diameter of the second wire 20a. Also, the distance between one second protrusion portion 35b and the other second protrusion portion 35c next to each other is larger than the diameter of the second wire 20a. Moreover, the distance between one second protrusion portion 35a (35b) and the other second protrusion portion 35b (35c) is larger than the distance between one first protrusion portion 34 and the other first protrusion portion 34 next to each other. The distance between one second protrusion portion 35a (35b) and the other second protrusion portion 35b (35c) is not limited, but may be twice or more or four times or more the diameter of the second wire 20a.

The distance between the second protrusion portion 35a and the partition protrusion portion 36 next to each other in the X-axis direction is larger than the diameter of the second wire 20a. The distance between the second protrusion portion 35a and the partition protrusion portion 36 is not limited and may be twice or more the diameter of the second wire 20a.

The distance between the second protrusion portion 35c and the flange portion 39b next to each other in the X-axis direction is larger than the diameter of the first wire 10a. The distance between the second protrusion portion 35c and the flange portion 39b next to each other is smaller than the diameter of the second wire 20a, but may be equal to or larger than the diameter of the second wire 20a.

Here, the section between the partition protrusion portion 36 and the second protrusion portion 35a is referred to as a “first section 70a”, and the section between the second protrusion portion 35a and the second protrusion portion 35b is referred to as a “second section 70b”, the section between the second protrusion portion 35b and the second protrusion portion 35c is referred to as a “third section 70c”, and the section between the second protrusion portion 35c and the flange portion 39b is referred to as a “fourth section 70d”. The distances between the first section 70a to the fourth section 70d are different, but may be equal to each other.

The second protrusion portion 35a is disposed between one first protrusion portion 34 and the other first protrusion portion 34 next to each other. The second protrusion portion 35b is disposed between one first protrusion portion 34 and the other first protrusion portion 34 next to each other. The second protrusion portion 35c is disposed between the first protrusion portion 34 and the flange portion 39b. Note that, a second protrusion portion may be disposed between the first protrusion portion 34 and the partition protrusion portion 36.

Hereinafter, a region of the tube portion 38 located between the partition protrusion portion 36 and the flange portion 39b along the X-axis direction is referred to as a “first region 31”. Also, a region of the tube portion 38 located between the partition protrusion portion 36 and the flange portion 39a along the X-axis direction is referred to as a “second region 32”. The partition protrusion portion 36 is located between the first region 31 and the second region 32 and partitions them. The width of the first region 31 in the X-axis direction is larger than the width of the second region 32 in the X-axis direction, but may be equal to or smaller than the width of the second region 32 in the X-axis direction. The first protrusion portion 34 and the second protrusion portions 35a to 35c are located in the first region 31.

As shown in FIG. 5, the first coil 10 includes a first portion 11 disposed (wound) in the first region 31 and a second portion 12 disposed (wound) in the second region 32. As shown in FIG. 6, the second coil 20 is disposed (wound) outside the first portion 11 in the first region 31. In other words, the first portion 11 is a portion disposed inside the second coil 20. The second portion 12 is next to the first portion 11 and the second coil 20 along the X-axis. Note that, the core axis of the tube portion 38, the winding axis of the first coil 10 (the first portion 11 and the second portion 12), and the winding axis of the second coil 20 are parallel to each other.

The number of layers of the first portion 11 in its radial direction is one, but may be plural. The number of layers of the second portion 12 in its radial direction is two, but may be one or three or more. The first portion 11 and the first layer of the second portion 12 are continuous. Thus, it is possible to prevent variations in the winding shape and winding position of the first coil 10 between the first portion 11 and the first layer of the second portion 12. The number of layers of the second coil 20 in its radial direction is two, but may be one or three or more.

The first portion 11 and the second portion 12 are formed on the outer peripheral surface of the tube portion 38, but may be formed directly on the outer peripheral surfaces of the cores 50a to 50d. The second coil 20 is formed on (in contact with) the outer peripheral surface of the first portion 11, but for example, an insulating member may be disposed between the first portion 11 and the second coil 20.

The first portion 11 includes mutually continuous first turn portions 13. One of the first turn portions 13 is disposed between one first protrusion portion 34 and the other first protrusion portion 34 next to each other. One of the first turn portions 13 is disposed between the first protrusion portion 34 and one of the second protrusion portions 35a to 35c next to each other. One of the first turn portions 13 is disposed between the partition protrusion portion 36 and the first protrusion portion 34 next to each other. One of the first turn portions 13 is disposed between the flange portion 39b and the second protrusion portion 35c next to each other.

One of the first protrusion portion 34, the second protrusion portion 35a, the second protrusion portion 35b, and the second protrusion portion 35c is disposed between one first turn portion 13 and the other first turn portion 13 next to each other. Thus, one first turn portion 13 and the other first turn portion 13 are separated from each other along the X-axis. The leakage magnetic flux between the first coil 10 and the second coil 20 can be adjusted to an appropriate value by adjusting the distance between one first turn portion 13 and the other first turn portion 13 (particularly, by arranging the first turn portions 13 sparsely rather than densely) depending on the width of the first protrusion portion 34 or the second protrusion portions 35a to 35c in the X-axis direction (or regardless of the width of the first protrusion portion 34 or the second protrusion portions 35a to 35c in the X-axis direction). The distance between one first turn portion 13 and the other first turn portion 13 is equal to the width of the first protrusion portion 34 or the second protrusion portions 35a to 35c in the X-axis direction, but may be larger than the width of the first protrusion portion 34 or the second protrusion portions 35a to 35c in the X-axis direction. For example, the distance between one first turn portion 13 and the other first turn portion 13 may be ⅕ times or more and 2 times or less the diameter of the first wire 10a.

A single first turn portion 13 is disposed between one first protrusion portion 34 and the other first protrusion portion 34 next to each other. In this case, the single first turn portion 13 is interposed between one first protrusion portion 34 and the other first protrusion portion 34. Thus, the winding position of each of the first turn portions 13 is fixed, and it is possible to prevent variations in the winding shape and winding position of the first portion 11. This makes it easy to adjust the leakage magnetic flux between the first coil 10 and the second coil 20. However, two or more first turn portions 13 may be arranged next to each other in the X-axis direction between one first protrusion portion 34 and the other first protrusion portion 34 and may be arranged next to each other in the radial direction of the tube portion 38.

Likewise, a single first turn portion 13 is provided between the first protrusion portion 34 and one of the second protrusion portions 35a to 35c next to each other. In this case, the single first turn portion 13 is interposed between the first protrusion portion 34 and one of the second protrusion portions 35a to 35c. Thus, the winding position of each of the first turn portions 13 is fixed, and it is possible to prevent variations in the winding shape and winding position of the first portion 11. This makes it easy to adjust the leakage magnetic flux between the first coil 10 and the second coil 20. However, two or more first turn portions 13 may be arranged next to each other in the X-axis direction between one first protrusion portion 34 and one of the second protrusion portions 35a to 35c and may be arranged next to each other in the radial direction of the tube portion 38.

One of the first turn portions 13 is disposed next to the first protrusion portion 34 along the X-axis. One of the first turn portions 13 may be in contact with the first protrusion portion 34 located on its one side in the X-axis direction or with the first protrusion portions 34 located on its both sides in the X-axis direction. In this case, the first portion 11 can be formed in the first region 31 while fixing the first turn portion 13 (the first wire 10a) to the first protrusion portion 34. Thus, it is possible to prevent variations in the winding shape and winding position of the first portion 11.

One of the first turn portions 13 is disposed next to the second protrusion portions 35a to 35c along the X-axis. One of the first turn portions 13 may be in contact with the second protrusion portions 35a to 35c located on its one side in the X-axis direction. In this case, the first portion 11 can be formed in the first region 31 while fixing the first turn portion 13 (the first wire 10a) to the second protrusion portions 35a to 35c. Thus, it is possible to prevent variations in the winding shape and winding position of the first portion 11.

One of the first turn portions 13 may be in contact with the partition protrusion portion 36. Also, one of the first turn portions 13 may be in contact with the flange portion 39b. In this case, the first portion 11 can be formed in the first region 31 while fixing the first turn portion 13 (the first wire 10a) to the partition protrusion portion 36 and/or the flange portion 39b, and it is possible to prevent variations in the winding shape and winding position of the first portion 11.

Note that, one of the first turn portions 13 may be disposed separately from the first protrusion portion 34 located on its one side in the X-axis direction or from the first protrusion portions 34 located on its both sides in the X-axis direction. That is, a gap (or gaps) may be formed between the first turn portion(s) 13 and the first protrusion portion(s) 34. Likewise, a gap may be formed between the first turn portion 13 and one of the second protrusion portions 35a to 35c, between the first turn portion 13 and the partition protrusion portion 36, or between the first turn portion 13 and the flange portion 39b.

The second coil 20 includes mutually continuous second turn portions 23. In the first layer of the second coil 20, the second turn portion 23 may be disposed on the first turn portion 13 and the first protrusion portion 34 while crossing over the first turn portion 13 and the first protrusion portion 34 next to each other. For more detail, the second turn portions 23 may be fixed in recesses (or gaps) between the first turn portions 13 and the first protrusion portions 34. In this case, the second turn portions 23 are less likely to be displaced, the positional relations between the first turn portions 13 and the second turn portions 23 are optimized, and the leakage magnetic flux between the first coil 10 and the second coil 20 can be adjusted to an appropriate value.

As described above, when the protrusion length of the first protrusion portions 34 is equal to the diameter of the first wire 10a, the steps between the first turn portions 13 and the first protrusion portions 34 can be reduced. Thus, when the second turn portions 23 are disposed on the first turn portions 13 and the first protrusion portions 34, the positional displacement of the second turn portions 23 can be prevented.

Note that, the second turn portions 23 do not necessarily have to be mounted on the first protrusion portions 34. For example, one of the second turn portions 23 may be mounted on one first turn portion 13 and the other first turn portion 13 next to each other while crossing over one first turn portion 13 and the other first turn portion 13. In this case, the second turn portion 23 can be fixed in a recess (or gap) between one first turn portion 13 and the other first turn portion 13, and the positional displacement of the second turn portions 23 can be prevented. Thus, the positional relations between the first turn portions 13 and the second turn portions 23 are optimized, and the leakage magnetic flux between the first coil 10 and the second coil 20 can be adjusted to an appropriate value. Instead, the second turn portion 23 may be mounted on a single first turn portion 13 without crossing over two first turn portions 13.

In the first layer of the second coil 20, one second turn portion 23 and the other second turn portion 23 next to each other are in contact with each other, but may be separated from each other. Preferably, from the viewpoint of preventing positional displacement, the second turn portions 23 next to the second protrusion portions 35a to 35c are in contact with the second protrusion portions 35a to 35c. Variations in the winding shape and winding position of the second turn portion 23 can be prevented by bringing the second turn portions 23 into contact with the second protrusion portions 35a to 35c and fixing these positions. However, a gap may be formed between the second turn portion 23 and one of the second protrusion portions 35a to 35c.

Preferably, from the viewpoint of preventing positional displacement, the second turn portion 23 next to the partition protrusion portion 36 is in contact with the partition protrusion portion 36. Variations in the winding shape and winding position of the second turn portions 23 can be prevented by bringing the second turn portions 23 into contact with the partition protrusion portions 36 and fixing these positions. However, gaps may be formed between the second turn portions 23 and the partition protrusion portions 36.

Note that, according to the research by the present inventors, it is revealed that variations in the leakage magnetic flux between the first coil 10 and the second coil 20 are greatly affected by variations in the winding shape and winding position of the second coil 20. As described above, variations in leakage magnetic flux caused by variations in the winding shape and winding position of the second coil 20 can be prevented by bringing the second turn portions 23 into contact with the second protrusion portions 35a to 35c and/or the partition protrusion portions 36.

The number of second turn portions 23 in the second layer (outermost layer) of the second coil 20 is smaller than that in the first layer of the second coil 20. However, the number of second turn portions 23 in the second layer of the second coil 20 may be equal to or larger than the number of second turn portions 23 in the first layer of the second coil 20. In the second layer (outermost layer) of the second coil 20, from the viewpoint of preventing positional displacement, one of the second turn portions 23 is preferably in contact with one of the second protrusion portions 35a to 35c. In the second layer (outermost layer) of the second coil 20, from the viewpoint of preventing positional displacement, one of the second turn portions 23 is preferably in contact with the partition protrusion portion 36. In this case, since the second turn portion 23 is fixed to one of the second protrusion portions 35a to 35c and/or the partition protrusion portion 36 in the second layer (outermost layer) of the second coil 20, it is possible to prevent variations in the winding shape and winding position of the second turn portion 23.

In the first portion 11 of the first coil 10, the number of first turn portions 13 arranged in the first section 70a is two, but may be one or three or more. In the first layer of the second coil 20, the number of second turn portions 23 arranged in the first section 70a is two, but may be one or three or more. In the second layer (outermost layer) of the second coil 20, the number of second turn portions 23 arranged in the first section 70a is one, but may be plural. The same applies to the third section 70c.

In the first portion 11 of the first coil 10, the number of first turn portions 13 arranged in the second section 70b is four, but may be one to three or five or more. In the first layer of the second coil 20, the number of second turn portions 23 arranged in the second section 70b is four, but may be one to three or five or more. In the second layer of the second coil 20, the number of second turn portions 23 arranged in the second section 70b is two, but may be one or three or more. Note that, in the fourth section 70d, the second turn portion 23 is not disposed, but may be disposed in one or more layers in the X-axis direction or in one layer or two or more layers in the radial direction.

In the present embodiment, a part of the first layer of the second coil 20 can be formed by continuously winding the second wire 20a in two turns in the first section 70a. Also, a part of the first layer of the second coil 20 can be formed by continuously winding the second wire 20a in four turns in the second section 70b. Also, a part of the first layer of the second coil 20 can be formed by continuously winding the second wire 20a in two turns in the third section 70c. Since the second wire 20a can be wound continuously in the first section 70a to the third section 70c, the second coil 20 is easily formed.

In the second region 32, the second portion 12 of the first coil 10 consists of two layers along the radial direction. The second portion 12 is disposed between the partition protrusion portion 36 and the flange portion 39a. In the second region 32, from the viewpoint of preventing positional displacement, one of the first turn portions 13 may be in contact with the flange portion 39a. From the viewpoint of preventing positional displacement, one of the first turn portions 13 may be in contact with the partition protrusion portion 36. The partition protrusion portion 36 may protrude more outward than the outer peripheral surface of the second portion 12 along the radial direction of the tube portion 38.

As shown in FIG. 2, the first coil 10 includes lead portions 14a and 14b. The lead portion 14a is raised from the second layer of the second portion 12 (FIG. 6), for example, at a position next to the partition protrusion portion 36 and led out to the terminal block 40a. The lead portion 14b is raised from the first portion 11, for example, at a position next to the flange portion 39b (FIG. 5). Then, the lead portion 14b is led out to the terminal block 40a while passing over the outer peripheral surfaces of the second coil 20 and the first coil 10 (second portion 12).

The second coil 20 includes lead portions 24a and 24b. The lead portion 24a is raised from the first layer of the second coil 20, for example, at a position next to the second protrusion portion 35c (FIG. 6) and led out to the terminal block 40b. The lead portion 24b is raised from the second layer of the second coil 20, for example, at a position next to the second protrusion portion 35c.

As shown in FIG. 1, the terminals 60a and 60b are attached to the terminal block 40a, and the terminals 60c and 60d are attached to the terminal block 40b. As shown in FIG. 2, each of the terminals 60a to 60d may include a fixation portion 61, a joint portion 62, and a wire connection portion 63.

The fixation portion 61 is a portion fixed to the terminal block 40a or 40b. The fixation portion 61 of the terminal 60a is attached to a terminal fixation portion 41m (FIG. 3) of the terminal block 40a. The fixation portion 61 of the terminal 60b is attached to the terminal fixation portion 41n (FIG. 3) of the terminal block 40a. The fixation portion 61 of the terminal 60c is attached to the terminal fixation portion 41m (FIG. 3) of the terminal block 40b. The fixation portion 61 of the terminal 60d is attached to the terminal fixation portion 41n (FIG. 3) of the terminal block 40b. Note that, a fastener (e.g., bolt) may be inserted into a through hole formed in the fixation portion 61. The terminal block 40a or 40b may be provided with a member (e.g., nut) for engaging with this fastener.

The wire connection portion 63 is a portion connected with the lead portion 14a, 14b, 24a, or 24b. The wire connection portion 63 has a C shape and is configured to sandwich the lead portion 14a, 14b, 24a, or 24b. However, the shape of the wire connection portion 63 is not limited to this and may have, for example, a ring shape. The lead portions 14a, 14b, 24a, or 24b may be laser-welded to the wire connection portion 63.

The joint portion 62 is a portion located between the fixation portion 61 and the wire connection portion 63 and connecting them. At least a part of the joint portion 62 of the terminal 60a may be disposed in the groove portion 42m (FIG. 3) of the terminal block 40a. At least a part of the joint portion 62 of the terminal 60b may be disposed in the groove portion 42n of the terminal block 40a. At least a part of the joint portion 62 of the terminal 60c may be disposed in the groove portion 42m of the terminal block 40b. At least a part of the joint portion 62 of the terminal 60d may be disposed in the groove portion 42n of the terminal block 40b.

Next, a method of manufacturing a coil device 1 is described. First, each member shown in FIG. 2 is prepared. Terminals 60a to 60d may be integrally formed with a bobbin 30. Instead, the terminals 60a to 60d may be retrofitted to the bobbin 30.

Next, as shown in FIG. 5, a first coil 10 is formed around a tube portion 38 of the bobbin 30. For more detail, a first portion 11 of the first coil 10 is formed in a first region 31 of the tube portion 38 as follows. First, the first wire 10a is wound around a fourth section 70d between a flange portion 39b and a second protrusion portion 35c. Next, the first wire 10a is transferred to a third section 70c next to the fourth section 70d via a notch 37 (FIG. 3) of the second protrusion portion 35c. Then, in the third section 70c, the first wire 10a is wound between a first protrusion portion 34 and the second protrusion portion 35c (35b) next to each other. Next, the first wire 10a is transferred to a second section 70b next to the third section 70c via a notch 37 (FIG. 3) of the second protrusion portion 35b. Then, in the second section 70b, the first wire 10a is wound between the first protrusion portion 34 and the second protrusion portion 35b (35a) next to each other and between one first protrusion portion 34 and the other first protrusion portion 34 next to each other. Next, the first wire 10a is transferred to a first section 70a next to the second section 70b via a notch 37 (FIG. 3) of the second projection 35a. Then, in the first section 70a, the first wire 10a is wound between the first protrusion portion 34 and the second protrusion portion 35a next to each other and between the first protrusion portion 34 and a partition protrusion portion 36 next to each other. Accordingly, the first portion 11 (first turn portions 13) is formed in the first region 31.

Next, a second portion 12 of the first coil 10 is formed in a second region 32 of the tube portion 38 as follows. First, the first wire 10a is transferred from the first region 31 to the second region 32 via a notch 37 (FIG. 3) of the partition protrusion portion 36. Then, the first wire 10a is wound around the outer peripheral surface of the tube portion 38 from the partition protrusion portion 36 toward the flange portion 39a to form a first layer of the second portion 12. Next, the first wire 10a is wound around the outside of the first layer from the flange portion 39a toward the partition protrusion portion 36 to form a second layer of the second portion 12. Accordingly, the second portion 12 is formed in the second region 32.

Next, as shown in FIG. 6, the second coil 20 is formed around the outside of the first coil 10 as follows. First, in the third section 70c, the winding of the second wire 20a around the outside of the first portion 11 is started from a position next to the second protrusion portion 35c. Next, the second wire 20a is transferred to the second section 70b next to the third section 70c via the notch 37 (FIG. 3) of the second protrusion portion 35b. Then, in the second section 70b, the second wire 20a is wound around the outside of the first portion 11. Next, the second wire 20a is transferred to the first section 70a next to the second section 70b via the notch 37 (FIG. 3) of the second protrusion portion 35a. Then, in the first section 70a, the second wire 20a is wound around the outside of the first portion 11. Thus, the first layer of the second coil 20 is formed.

Next, in the first section 70a, the second wire 20a is wound around the outside of the first layer of the second coil 20 to form a second layer of the second coil 20. Next, the second wire 20a is transferred to the second section 70b next to the first section 70a via the notch 37 (FIG. 3) of the second protrusion portion 35a. Then, in the second section 70b, the second wire 20a is wound around the outside of the first layer of the second coil 20. Next, the second wire 20a is transferred to the third section 70c next to the second section 70b via the notch 37 (FIG. 3) of the second protrusion portion 35b. Then, in the third section 70c, the second wire 20a is wound around the outside of the first layer of the second coil 20. Accordingly, the second coil 20 is formed.

Next, as shown in FIG. 1, a lead portion 14a of the first coil 10 is connected to a wire connection portion 63 (FIG. 2) of the terminal 60a. Also, a lead portion 14b of the first coil 10 is connected to a wire connection portion 63 (FIG. 2) of the terminal 60b. Also, a lead portion 24a of the second coil 20 is connected to a wire connection portion 63 (FIG. 2) of the terminal 60c. Also, a lead portion 24b of the second coil 20 is connected to a wire connection portion 63 (FIG. 2) of the terminal 60d. If necessary, the lead portions 14a, 14b, 24a, and 24b may be laser-welded.

Next, cores 50a to 50d are attached to the bobbin 30. For more detail, a middle leg portion 53 (FIG. 2) of each of the cores 50a to 50d is engaged with a through hole 38a (FIG. 3) of the tube portion 38. If necessary, the cores 50a to 50d may be adhered to each other. Accordingly, the coil device 1 can be manufactured.

In the present embodiment, as shown in FIG. 6, when the second coil 20 is provided outside the first portion 11 of the first coil 10, the effect of reducing leakage magnetic flux is exhibited. Moreover, when the second coil 20 is next to the second portion 12 of the first coil 10 along the X-axis, the effect of increasing leakage magnetic flux is exhibited. Thus, the coil device 1 has a portion for contributing to reduction in leakage magnetic flux and a portion for contributing to increase in leakage magnetic flux. Then, the leakage magnetic flux between the first coil 10 and the second coil 20 can be adjusted to an appropriate value by organically combining these portions

In particular, in the present embodiment, since the first protrusion portions 34 are formed in the first region 31, the first portion 11 can be formed in the first region 31 while fixing the first wire 10a to the first protrusion portions 34. This makes it possible to prevent variations in the winding shape and winding position of the first portion 11. Moreover, the second protrusion portions 35a to 35c are formed in the first region 31, and the partition protrusion portion 36 is formed between the first region 31 and the second region 32. Thus, the second coil 20 can be formed outside the first portion 11 while fixing the second wire 20a to the second protrusion portions 35a to 35c and to the partition protrusion portion 36. This makes it possible to prevent variations in the winding shape and winding position of the second coil 20. As a result, a winding disorder is less likely to occur in the first coil 10 (the first portion 11) and/or the second coil 20, and it is possible to prevent variations in the leakage magnetic flux between the first coil 10 and the second coil 20.

Also, as shown in FIG. 3, the notches 37 are formed in the first protrusion portions 34. Thus, as shown in FIG. 5, when the first portion 11 is formed in the first region 31, the first wire 10a can be wound from one side to the other side via the notches 37 along the X-axis without being hindered by the first protrusion portions 34.

Also, as shown in FIG. 3, the notches 37 are formed in the second protrusion portions 35a to 35c. Thus, as shown in FIG. 5, when the second coil 20 is formed in the first region 31, the second wire 20a can be wound from one side to the other side via the notches 37 along the X-axis without being hindered by the second protrusion portions 35a to 35c.

Note that, the present disclosure is not limited to the above-described embodiment and may variously be modified within the scope of the present disclosure. For example, in the above-described embodiment, an application example of the present disclosure to a leakage transformer is described, but the present disclosure is also applicable to transformers other than leakage transformers.

In the above-described embodiment, as shown in FIG. 3, the widths of the first protrusion portions 34 in the X-axis direction are equal to each other, but may be different from each other. For example, the width in the X-axis direction of the first protrusion portion 34 next to the partition protrusion portion 36 may be larger than the widths of the other first protrusion portions 34 in the X-axis direction. Moreover, each of the first protrusion portions 34 may be provided with at least one portion having a large width in the X-axis direction (wide portion) and at least one portion having a small width in the X-axis direction (narrow portion). The wide portion and the narrow portion may be arranged along the extending direction (circumferential direction) of each of the first protrusion portions 34. Note that, the width of the narrow portion in the X-axis direction may be ½ or less or ⅓ or less of the width of the wide portion in the X-axis direction.

In the above-described embodiment, as shown in FIG. 3, the widths of the second protrusion portions 35a to 35c in the X-axis direction are equal to each other, but may be different from each other. For example, the width of the second protrusion portion 35c in the X-axis direction may be larger than the width of the second protrusion portion 35a or 35b in the X-axis direction. Moreover, each of the second protrusion portion 35a to 35c may be provided with at least one portion having a large width in the X-axis direction (wide portion) and at least one portion having a small width in the X-axis direction (narrow portion). The wide portion and the narrow portion may be arranged along the extending direction (circumferential direction) of each of the second protrusion portions 35a to 35c. Note that, the width of the narrow portion in the X-axis direction may be ½ or less or ⅓ or less of the width of the wide portion in the X-axis direction.

In the above-described embodiment, the bobbin 30 may be omitted from the coil device 1. In this case, the cores 50a to 50d (e.g., the middle leg portions 53 of the cores 50a to 50d) may be provided with the first coil 10.

In the above-described embodiment, the first coil 10 and the second coil 20 may be air-core coils.

In the above-described embodiment, as shown in FIG. 3, a plurality of first protrusion portions 34 is formed on the outer peripheral surface of the tube portion 38, but the number of first protrusion portions 34 may be one. Also, a plurality of second protrusion portions 35a to 35c is formed on the outer peripheral surface of the tube portion 38, but the number of second protrusion portions may be one.

### DESCRIPTION OF THE REFERENCE NUMERICAL

1 . . . coil device
10 . . . first coil
10a . . . first wire
11 . . . first portion
12 . . . second portion
13 . . . first turn portion
14a, 14b . . . lead portion
20 . . . second coil
20a . . . second wire
23 . . . second turn portion
24a, 24b . . . lead portion
30 . . . bobbin
31 . . . first region
32 . . . second region
34 . . . first protrusion portion
35a-35c . . . second protrusion portion
36 . . . partition protrusion portion
37 . . . notch
38 . . . tube portion
38a . . . through hole
39a, 39b . . . flange portion
40a, 40b . . . terminal block
41m, 41n . . . terminal fixation portion
42m, 42n . . . flange portion
43 . . . insulating portion
44a, 44b . . . leg portion
50a-50d . . . core
51 . . . base portion
52 . . . outer leg portion
53 . . . middle leg portion
54 . . . base recess portion
55 . . . outer leg recess portion
60a-60d . . . terminal
61 . . . fixation portion
62 . . . joint portion
63 . . . wire connection portion
70a-70d . . . first section to fourth section

What is claimed is:

1. A coil device comprising:
a bobbin;
a first coil provided to the bobbin; and
a second coil provided outside the first coil;
wherein
the first coil includes:
a first portion provided inside the second coil; and
a second portion next to the first portion and the second coil along a winding axis of the first portion,
the bobbin includes:
a first region for disposing the first portion; and
a second region for disposing the second portion,
a first protrusion portion, a second protrusion portion, and a partition protrusion portion each protruding in a radial direction of the bobbin are formed on an outer peripheral surface of the bobbin,
the first protrusion portion is located in the first region,
the second protrusion portion is located in the first region and protrudes more outward than the first protrusion portion in the radial direction of the bobbin, and
the partition protrusion portion is located between the first region and the second region and protrudes more outward than the first protrusion portion in the radial direction of the bobbin.

2. The coil device according to claim 1, wherein
the first protrusion portion comprises first protrusion portions provided along an axial direction of the bobbin, and
the second protrusion portion is provided between the first protrusion portions next to each other in the first region.

3. The coil device according to claim 1, wherein
the second coil includes mutually continuous second turn portions,
one of the second turn portions is in contact with the second protrusion portion, and
another one of the second turn portions is in contact with the partition protrusion portion.

4. The coil device according to claim 3, wherein
the second coil includes layers provided along the radial direction of the bobbin,
one of the second turn portions in an outermost layer of the second coil is in contact with the second protrusion portion, and
another one of the second turn portions in the outermost layer of the second coil is in contact with the partition protrusion portion.

5. The coil device according to claim 3, wherein
the second protrusion portion comprises second protrusion portions provided along the axial direction of the bobbin, and
the second turn portions are provided between the second protrusion portions next to each other.

6. The coil device according to claim 1, wherein
the first protrusion portion comprises first protrusion portions provided along the axial direction of the bobbin,
the first portion includes mutually continuous first turn portions, and
one of the first turn portions is provided between the first protrusion portions next to each other.

7. The coil device according to claim 1, wherein the first portion and a first layer of the second portion are continuous to each other.

8. The coil device according to claim 1, wherein
the first coil is formed by a first wire wound in a coil shape,
the second coil is formed by a second wire wound in a coil shape,
the first protrusion portion and the second protrusion portion extend along a circumferential direction of the bobbin,
the bobbin includes:
a first notch formed at a part of an extension direction of the first protrusion portion; and
a second notch formed at a part of an extension direction of the second protrusion portion,
the first wire passes through the first notch, and
the second wire passes through the second notch.

9. The coil device according to claim 1, wherein
the first coil is formed by a first wire wound in a coil shape, and
a protrusion length of the first protrusion portion is equal to a diameter of the first wire.
